(19) United States
(12) Patent Application Publication
(10) Pub. No.: US 2011/0106564 A1
(43) Pub. Date: May 5, 2011

(54) Electronic medical records interoperability

(76) Inventors: Don Hachmeister, Aurora, IL (US); Gerald Galloway, Berwin, IL (US); Michael G. Gaeta, West Nyack, NY (US)

(21) Appl. No.: 12/925,810

(22) Filed: Oct. 29, 2010

Related U.S. Application Data
(60) Provisional application No. 61/256,654, filed on Oct. 30, 2009.

(51) Int. Cl. G06Q 50/00; G06Q 10/00

(52) U.S. Cl. 705/3

(57) ABSTRACT

In accordance with the principles of the present invention, an electronic medical record system is provided. A clinical web server connects to at least two information technology systems and providing real time exchange of data between existing databases. The clinical web server translates and maps existing databases into a common data structure format. A message to be transmitted is generated. Routing type and formatting routing are determined based on recipient delivery requirements. The message is parsed into segments and fields. The appropriate party to whom the message is directed is determined. Identifiers in the message are translated from a sender's value to a recipient's value. The message is translated from a sender's format to a recipient's format.

### CROSS REFERENCE TO RELATED APPLICATIONS

This application claims priority to U.S. Provisional Patent Application Ser. No. 61/256,654 filed 30 Oct. 2009.

### FIELD OF THE INVENTION

The present invention relates to electronic medical records.

### BACKGROUND OF THE INVENTION

Healthcare providers perform innumerable treatment services. The performance of such services is often documented in varying degrees of detail to serve various purposes. The condition and response of patients who receive healthcare services are also documented. For example, records are often kept in regard to each instance that service is rendered so that the course of treatment for the patient can be readily accessible. Healthcare professionals will periodically document the health condition of patients to gauge their progress under medical supervision or to simply assess their overall health.

A medical record (also known as a health record or medical chart) is a systematic documentation of a patient's individual medical history and care. The term ‘medical record’ is used both for the physical folder for each individual patient and for the body of information which comprises the total of each patient's health history. The information contained in the medical record allows healthcare providers to provide continuity of care to individual patients. The medical record also serves as a basis for planning patient care, documenting communication between the healthcare provider and any other health professional contributing to the care of a patient, assisting in protecting the legal interest of the patient and the healthcare providers responsible for the care of the patient, and documenting the care and services provided to the patient. In addition, the medical record may serve as a document to educate medical students/resident physicians, to provide data for internal hospital auditing and quality assurance, and to provide data for medical research.

Thus, healthcare providers, such as physicians and therapists, create large volumes of patient information during the course of their business at healthcare facilities, such as hospitals, clinics, laboratories, medical offices, and the like. For example, when a patient visits a physician for the first time, the physician generally creates a patient file including the patient's medical history, current treatments, medications, insurance, and other pertinent information. This file generally includes the results of patient visits, including laboratory test results, the physician's diagnosis, medications prescribed, and treatments administered. During the course of the patient relationship, the physician supplements the file to update the patient's medical history. When the physician refers a patient for treatment, tests or consultation, the referred physician, hospital, clinic or laboratory typically creates and updates similar files for the patient. These files also may include the patient's billing, payment, and scheduling records.

Healthcare services are traditionally rendered by numerous providers who operate independently of one another. A single patient may obtain the services of a number of these providers when being treated for a particular illness or injury. Over the course of a lifetime, a patient may receive the services of a large number of providers. Each medical service provider typically maintains medical records for services the provider renders for a patient, but rarely has medical records generated by other providers. Each provider will identify a patient with a Medical Record Number (MRN) of its own choosing to track medical records the provider generates in connection with the patient.

Traditionally, medical records have been written on paper and kept in folders. These folders are typically divided into sections, with new information added to each section chronologically as the patient experiences new medical issues. Paper-based records require a significant amount of storage space compared to digital records. In the U.S., most states require physical records be held for a minimum of seven years or the age of majority for the state. The costs of storage media, such as paper and film, per unit of information differ dramatically from that of electronic storage media. When paper records are stored in different locations, collating them to a single location for review by a healthcare provider is time consuming and complicated, whereas the process can be simplified with electronic records. When paper-based records are required in multiple locations, copying, faxing, and transporting costs are significant compared to duplication and transfer of digital records.

While a significant number of healthcare providers utilize paper medical records, electronic medical records are known. An electronic medical record is usually a computerized medical record created in an organization that delivers care, such as a hospital or a physician group. The electronic medical record details each encounter between the patient and the provider for each episode of illness treated by the specific provider (hospital, physicians or other providers). Although the electronic medical record is commonly looked to as the medical legal record of that particular episode of illness and its management, it does not contain any information from other providers who do not have access or share the same specific electronic medical record. Electronic medical records tend to be a part of a local stand-alone health information system that allows storage, retrieval, and manipulation of records.

In order to make healthcare management more efficient, improve the quality of healthcare delivered, and eliminate inefficiencies in the delivery of the services and improve patient care, there has been a movement to collect all of a patient's medical records into a central location for access by healthcare managers and providers; however, there are several impediments to centralizing and sharing medical records. First, there is the cost in equipment, software, and personnel required in collecting and processing medical records at a central location, and in responding to requests for medical records. Medical records present special problems due to their diversity in form and content. In order to efficiently process the medical records for subsequent access, standardized procedures, forms, and reporting must be developed and adopted by the entire network of providers.

Second, there is the cost and reluctance of the independent medical service providers in conforming to standardized practices typically required for a central record keeping system. Since most medical service providers have preexisting or “legacy” record keeping systems, these would have to be converted and a unique medical record number or patient identifier assigned to each patient.

In addition, standardizing medical record keeping, including unique patient identifiers within a network, is complicated by the loose and fluid nature of such networks. Medical service providers are constantly added and dropped from networks and healthcare organizations may merge or split apart. Thus, a provider would not only have to keep multiple identifiers, the provider would also be further burdened with additional and changing standards. Providers are unlikely to have the resources and expertise to accommodate the requirements of changing or multiple networks.

Thus, it would therefore be desirable to provide for access by healthcare managers and providers to electronic medical records in an efficient, cost-effective manner.

### SUMMARY OF THE INVENTION

The present invention provides for access by healthcare managers and providers to electronic medical records in an efficient, cost-effective manner. In accordance with the principles of the present invention, an electronic medical record system is provided. A clinical web server connects to at least two information technology systems and providing real time exchange of data between existing databases. The clinical web server translates and maps existing databases into a common data structure format. Medical records are transmitted. A message to be transmitted is generated. Routing type and formatting routing are determined based on recipient delivery requirements. The message is parsed into segments and fields. The appropriate party to whom the message is directed is determined Identifiers in the message are translated from a sender's value to a recipient's value. The message is translated from a sender's format to a recipient's format.

### BRIEF DESCRIPTION OF THE DRAWING

FIG. 1 is a schematic of an electronic medical records interoperability system in accordance with the principles of the present invention.

FIG. 2 is a flow-chart describing the message transmission from an originating client to a server in accordance with the principles of the present invention.

FIG. 3 is a flow-chart describing the message transmission from a server to a recipient client in accordance with the principles of the present invention.

FIG. 4 is a flow-chart describing a message inbound translation process in accordance with the principles of the present invention.

FIG. 5 is a flow-chart describing a message outbound translation process in accordance with the principles of the present invention.

FIG. 6 is a non-limiting example of a high level hardware implementation can used to run a system of the present invention.

### DETAILED DESCRIPTION OF A PREFERRED EMBODIMENT

A significant problem in healthcare today is that thousands of systems and technologies have been deployed across hospitals and medical centers, doctor's offices and physician's groups, and laboratory and other clinical services providers, without the ability to share data and information and interoperate efficiently and effectively. Competitive positioning of providers in the marketplace, as well as the inability for legacy and new technologies to work together has led to the difficultly in creating an amalgamated approach to healthcare data. One estimate states that there are over 380 electronic medical record companies in the market and over dozens of hospital information systems. These systems simply cannot exchange records with other hospitals and many physician groups.

In addition, it is common for a physician or a group of physicians to work at multiple hospitals in an area. Each hospital can be on a different system, which cannot share data with the other hospital systems or with the physician's systems. Thus, a patient's complete medical history is not available, and often times duplicate tests must be given and errors can occur and records lost.

In accordance with the principles of the present invention, the many, various, and disparate systems of hospitals, physicians, medical groups, and other healthcare providers and data sources can intercommunicate and interoperate easily and securely. The present invention provides neural connectivity between current billing, medical records, clinics, and other point systems to facilitate the transition to an overall, integrated electronic medical records and health information system approach.

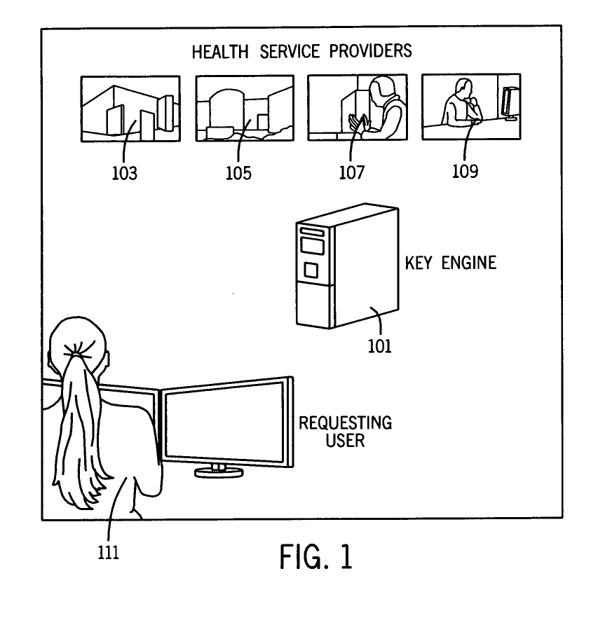

Referring to FIG. 1, a schematic of an electronic medical records interoperability system in accordance with the principles of the present invention is seen. A clinical web server is provided 101. The clinical web browser 101 accesses the information technology system of hospitals 103, physicians 105, medical groups 107, and other healthcare providers 109. The clinical web browser acts as a translator, mapping existing databases into a common data structure format. In one embodiment, the common data format is the Health Level Seven International (HL7) format.

An index of information is generated so that a requester 111 can determine what is important to them. The requester 111 can thus customize what is important to them to review based on their needs. A query generates a quick synopsis of a patient's history; allows the user to drill down to any access point; check recent tests, images, and laboratory results; access participating access points; and provides one access point to the patient's data. A master patient index is provided for each patent. The master patient index is correlated to each provider's own medical record number (MRN) of its own choosing.

The present invention interfaces provides for real time exchange of data between disparate databases. The present invention interfaces with existing installed hardware, operating, and application systems. The present invention seamlessly taps into existing systems. The providers existing workflow is not altered. Interoperability is achieved without the significant expenditure of a central location for medical records.

Referring physician generated Computerized Physician Order Entry (CPOE) orders can be inserted directly into laboratory or hospital systems, electronically and automatically. Referring physician electronic medical records can transfer their electronic orders directly to their laboratory, radiology or other providers, inserting the orders directly into the laboratory information system, the radiology information system or other provider information system. This is accomplished by leveraging the embedded master patient index, and a transmission system and transformative system described in detail below. Radiology, laboratory or other test results can be sent to the referring physician's electronic medical record system via the present invention. The results are inserted directly into the patient record by leveraging the embedded master patient index to identify the correct patient. Communications transport is industry standard/compliant HL7 format.

If the providers are not on an electronic medical record system, each laboratory information system, the radiology information system or other provider information system have their own results distribution fax server and associated table of recipients. With the present invention, these servers can be consolidated into a single point, with a single manageable distribution list. Results are received by the present invention via HL7 and faxed to their respective targets. When the referring physicians have moved to an electronic medical record system, their destination is then served electronically and results are inserted directly into their electronic medical record system. By distributing results directly into a referring physician's electronic medical record system, physicians can view results quicker and not worry about administrative delays. The present invention provides the interoperability to eliminate faxes, e-mails, and snail mail distribution of results.

One patient may visit several healthcare providers or locations. Each provider or location may give that patient a unique identifier. Tests are performed, and results are created and returned. When results are created, the present invention receives the results via HL7 and the location of the results is recorded in a database. In the case of a hospital inpatient, orders for tests and the associated results all happen within the walls of the hospital. When the results are available, the system of the present invention is notified via HL7 that there are results for that patient in the hospital system. The present invention updates its database with the location of the results. When the hospital orders laboratory work, the order traversed the present invention, which normalizes the patient identifier via the master patient index and passes the order to the laboratory. The laboratory generates the results, and passes the results back to the hospital via the system of the present invention, which again normalizes the patient identifier to the local hospital identifier. The system of the present invention also records the location of the laboratory results it its database.

A clinic may also order laboratory tests. When this happens, the order traversed the present invention, which normalizes the patient identifier via the master patient index and passes the order to the laboratory. The laboratory generates the results, and passes the results back to the clinic via the present invention, which again normalizes the patient identifier to the local clinic identifier. The present invention also records the location of the laboratory results it its database.

The patient's personal doctor may want to view the results from all the medical interventions. The doctor queries the present invention, which returns information about all of the results for the patient, no matter what patient identifier it was acquired under. The doctor may then retrieve and review the results. If the local health department wants to identify disease trends, they can query the present invention which can return aggregated results. This could be, in one example, the International Classification of Diseases (ICD-9) codes.

As an example of the patient healthcare interaction, a patient arrives at the doctor's office, and the receptionist locates him in the electronic medical records. The doctor sees the patient, examines him, makes notes about his condition, and orders a laboratory test in the electronic medical system. The electronic medical system sends an order request to the laboratory through the system of the present invention. The present invention searches the laboratory database for an identification of the patient. If a match is not found, then human intervention is requested; if a match is found, the present invention sends the order request to the laboratory. The present invention executes an internal master patient index lookup and matches the patient identifier from the doctor's office to the laboratory identifier, and sends the request to the laboratory with the laboratory's own local patient identifier. Results are sent back to the doctor through the present invention with the doctor's own local patient identifier.

Thus, in accordance with the principles of the present invention disparate systems are allowed to transmit formatted message between various parties. While the HL7 specification clearly defines the format for each message, many systems implement them using various customizations. The present invention overcomes this issue using a translate structure that converts non-standard messages into the appropriate standard, then reconverts it into the non-standard format expected on the receiving end. In addition to the translation functionality, the present invention also provides a transmission and routing system that avoids some of the networking and development headaches with the current standard architecture.

As previously referenced, the present invention comprises a transmission system. The transmission system is based off a Windows service application (client service) that is installed in a machine that has direct connectivity with the end point's system. This service monitors an inbound folder for new messages to transmit. Messages are delivered to the service through text files that are saved in this folder. When a message is received, the client service connects to a windows service on a central server. This transmission is accomplished using a HyperText Transfer Protocol (HTTP) Secure Sockets Layer (SSL) connection between the client and the server. When a message is received by the server, the message is stored in the central database for processing.

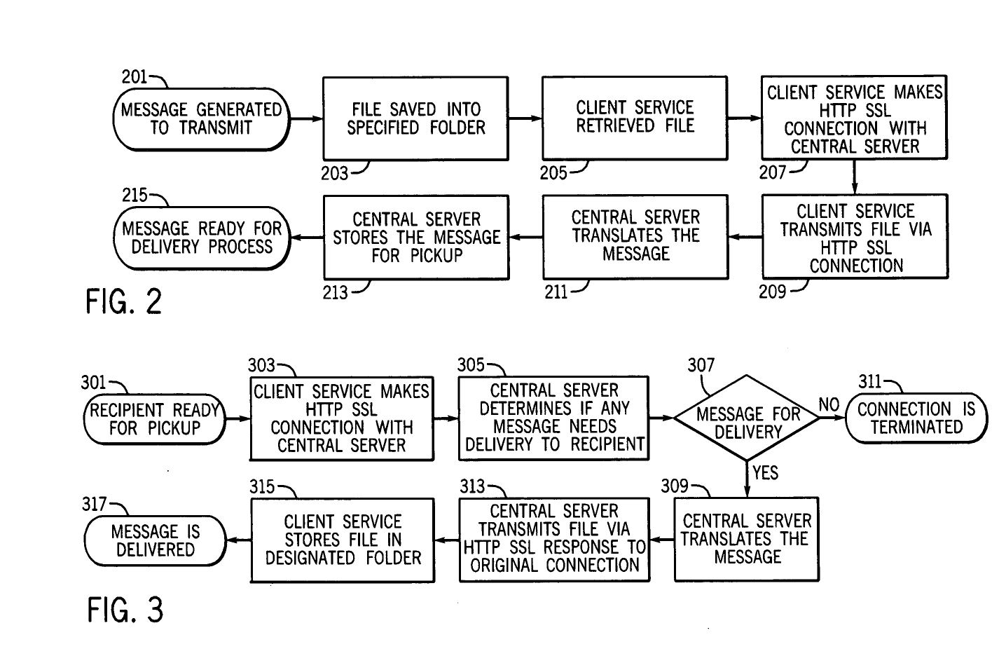

Referring to FIG. 2, a flow-chart is seen describing the message transmission from an originating client to the server. Initially, the message is generated to be transmitted 201. Then, the file is saved into specified folder 203. Then, the client service retrieves the file 205. Then, the client service makes an HTTP SSL connection with a central server 207. Then, the client service transmits the file via HTTP SSL connection 209. Then, the central server translates the message 211. Then, the central server then stores the message for pickup 213. Thus, the message is ready for the deliver process 215.

Messages to be transmitted from the central server to an end point (delivery of a message) are sent using the same HTTP SSL connection. The client service periodically polls the central service looking for a new message. Once a message is waiting, the server will transmit it to the client service as an HTTP SSL response to the request. The client service will deliver the file to a specific folder on the end point's system. This method of transmission allows the system to avoid the need for Virtual Private Network (VPN) connections since all calls are made from the end point to the server. The server does not need to have any direct knowledge of the location of the end point, Internet Protocol (IP) address, port or other security parameters.

Referring to FIG. 3, a flow-chart is seen describing the message transmission from the server to the recipient client. Initially, the client service poll of the central service determines that a recipient is ready for pick-up 301. Then, the client service makes an HTTP SSL connection with the central server 303. Then, the central server determines if any message needs delivery to recipient 305. A decision is implemented 307. If a message needs delivery to recipient, then the central server translates the message 309; if a message does not need delivery to recipient, then the connection is terminated 311. Once the message is translated by the central server, then the central server transmits the file via HTTP SSL response to the original connection 313. Then, the client service stores the file in a designated folder 315. Thus, the message is delivered 317.

Also as previously referenced, the present invention comprises a translation system. The translation system reads the incoming message and converts it into a standard HL7 message. Messages are translated at two distinct points: on transmission from an end point to the central server (inbound translation) and on delivery from the central server to the recipient end point (outbound translation). Messages are translated for several factors, including routing details, identifiers, custom translations, and versioning.

In routing details, the messages are evaluated to determine the appropriate party to whom the message is directed. Routing details can come in many different forms, including message header, provider identification, facility details, etc. The present invention can take custom routing formats and ensure the message is delivered to the right source. Once the message destination is determined, the message header is reformatted to insert the unique receiving application and facility IDentification (ID) defined within the routing system database.

The messages can include many identifiers that may be understandable by the sending party, but not by the recipient. Identifiers like provider ID, facility ID, test codes, etc. are translated from the sender's value to the expected recipient's value. The present invention does not limit the number of fields that can be translated.

Since some messages are not sent in a standard format, custom translations need to be coded on a customer basis. The translation system allows for the rapid insertion of custom translators that can be turned on and off at the database level for data sources. These translations can do anything to the message, including (but not limited to) moving fields into different positions, changing case, removing or adding message envelopes, etc.

Because not every system uses the same HL7 version, versioning is applied. The translation engine is aware of the version used by both the sender and the recipient and will translate the message from one format to the other. This could include concatenating some fields that may no longer exist in the recipient version, changing field orders, and reformatting the message from a delimited to an Extensible Markup Language (XML) format.

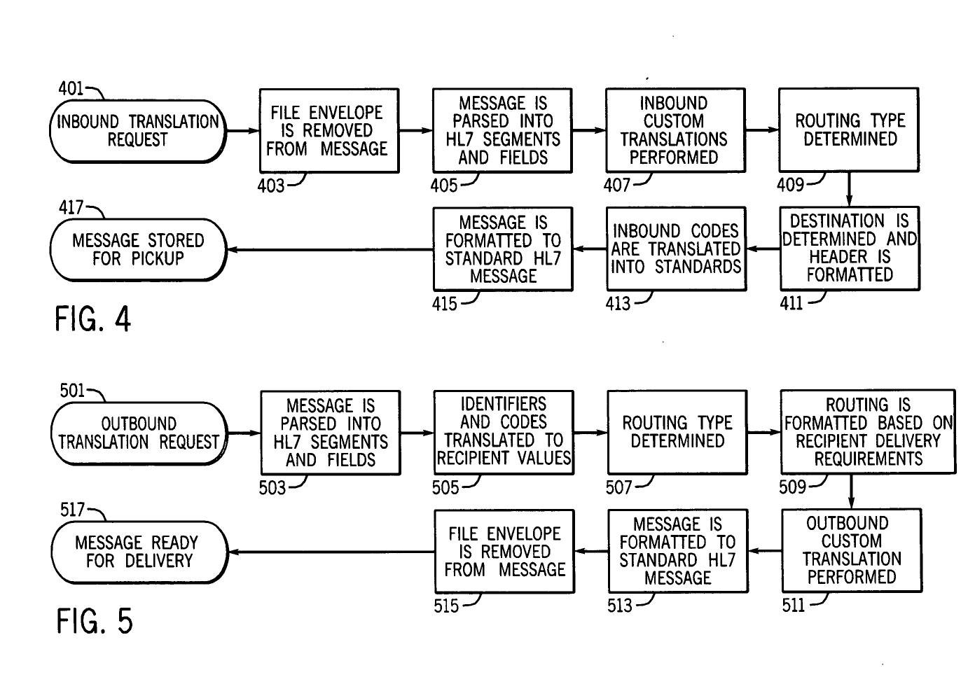

Referring to FIG. 4, a flow-chart is seen describing the message inbound translation process. Initially, an inbound translation request is generated 401. Then, the file envelope is removed from the message 403. Then, the message is parsed into HL7 segments and fields 405. Inbound custom translations are performed 407. The routing type is determined 409. The destination is determined and the header is formatted 411. Inbound codes are translated into standards 413. Then, the message is formatted into standard HL7 message 415. The message is stored for pickup 417. It should be noted that the majority of the steps described herein can be performed in any order.

Referring to FIG. 5, a flow-chart is seen describing the message outbound translation process. Initially, an outbound translation request is generated 501. Then, the message is parsed into HL7 segments and fields 503. Identifiers and codes are translated to recipient values 505. The routing type is determined 507. Routing is formatted based on recipient delivery requirements 509. Outbound custom translations are preformed 511. Then, the message is formatted into standard HL7 message 513. The file envelope is removed from the message 515. Thus, the message is ready for delivery 517. The next time the recipient contacts the server, the message will be returned. It should be noted that the majority of the steps described herein can be performed in any order.

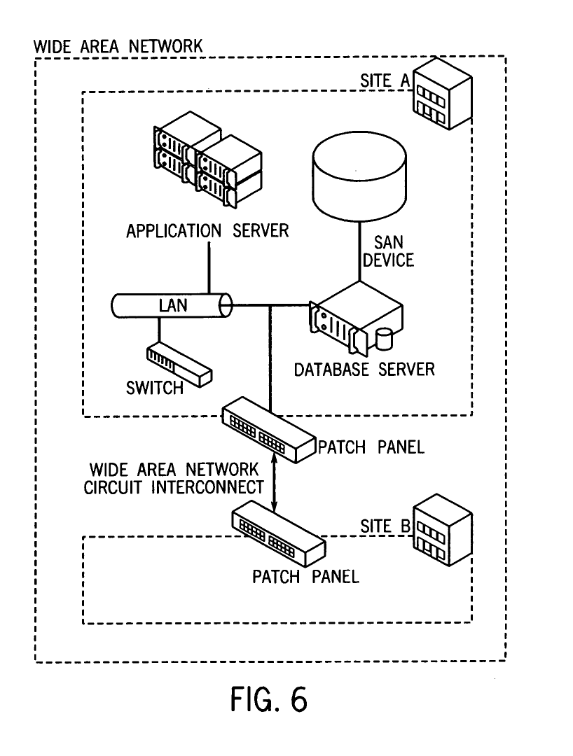

Referring to FIG. 6, a non-limiting example of a high level hardware implementation can used to run a system of the present invention is seen. The infrastructure should include but not be limited to: wide area network connectivity, local area network connectivity, appropriate network switches and routers, electrical power (backup power), storage area network hardware, server-class computing hardware, and an operating system such as for example Redhat Linux Enterprise AS Operating System available from Red Hat, Inc, 1801 Varsity Drive, Raleigh, N.C.

The application server can run for example on an HP ProLiant DL 360 G6 server with multiple Intel Xeon 5600 series processors with a processor base frequency of 3.33 GHz, up to 192 GB of RAM, 2 PCIE expansion slots, 1 GB or 10 GB network controllers, hot plug SFF SATA drives, and redundant power supplies, available from Hewlett-Packard, Inc, located at 3000 Hanover Street, Palo Alto, Calif. The database server can be run for example on a HP ProLiant DL 380 G6 server with multiple Intel Xeon 5600 series processors with a processor base frequency of 3.33 GHZ, up to 192 GB of RAM, 6 PCIE expansion slots, 16 SFF SATA drive bays, an integrated P410i integrated storage controller, and redundant power supply, available from Hewlett-Packard

While the invention has been described with specific embodiments, other alternatives, modifications, and variations will be apparent to those skilled in the art. Accordingly, it will be intended to include all such alternatives, modifications and variations set forth within the spirit and scope of the appended claims.

What is claimed is:

1. An electronic medical record system comprising:
at least two information technology systems having existing databases;
a clinical web server, the clinical web server connected to the at least two information technology systems and providing real time exchange of data between existing databases; and
the clinical web server translating and mapping existing databases into a common data structure format.

2. The electronic medical record system of claim 1 further wherein the common data structure format comprises Health Level Seven International (HL7) format.

3. The electronic medical record system of claim 1 further comprising an index of information.

4. The electronic medical record system of claim 3 further comprising a master patient index.

5. A method of transmitting medical records comprising:
generating a message to be transmitted;
determining routing type and formatting routing based on recipient delivery requirements;
parsing the message into segments and fields;
determining the appropriate party to whom the message is directed;
translating identifiers in the message from a sender's value to a recipient's value; and
translating the message from a sender's format to a recipient's format.

6. The method of transmitting medical records of claim 5 further comprising translating the message from a sender's format to a standard format, then translating the message from the standard format to an expected recipient's format.

7. The method of transmitting medical records of claim 6 further comprising translating the message from a sender's Health Level Seven International (HL7) format to a standard Health Level Seven International (HL7) format, then translating the message from the standard Health Level Seven International (HL7) format to an expected recipient's Health Level Seven International (HL7) format.

8. The method of transmitting medical records of claim 5 further comprising generating an Health Level Seven International (HL7) message to be transmitted and parsing the message into Health Level Seven International (HL7) segments and fields.

9. The method of transmitting medical records of claim 5 further comprising transmitting the file via an HyperText Transfer Protocol (HTTP) Secure Sockets Layer (SSL) connection.

10. The method of transmitting medical records of claim 5 further comprising transmitting the messages from a recipient end point to a central server.

11. The method of transmitting medical records of claim 5 further comprising transmitting the messages from a central server to a recipient end point.
